(19) United States
(12) Patent Application Publication
(10) Pub. No.: US 2015/0274913 A1
(43) Pub. Date: Oct. 1, 2015

(54) PREPREG, CARBON-FIBER-REINFORCED COMPOSITE MATERIAL, AND ROBOT HAND

(71) Applicant: JX NIPPON OIL & ENERGY CORPORATION, Tokyo (JP)

(72) Inventors: Shinichi TAKEMURA, Tokyo (JP); Daisuke UCHIDA, Tokyo (JP); Masaki MINAMI, Tokyo (JP)

(73) Assignee: JX NIPPON OIL & ENERGY CORPORATION, Tokyo (JP)

(21) Appl. No.: 14/672,465

(22) Filed: Mar. 30, 2015

(30) Foreign Application Priority Data
Apr. 1, 2014 (JP) 2014-075782

(51) Int. Cl. C08J 5/24; B32B 27/08; C08J 5/04

(52) U.S. Cl. CPC C08J 5/24; C08J 5/042; B32B 27/08; C08J 2361/14; C08J 2465/00; C08J 2481/06; B32B 2250/03; B32B 2250/40; B32B 2305/08; B32B 2262/106; B32B 2305/076; B32B 2307/54; B32B 2307/56; B32B 2307/546; B32B 2307/306; B32B 2307/7265

(57) ABSTRACT

Provided are a carbon-fiber-reinforced composite material having a low saturated water absorption and excellent TML, CVCM, and heat resistance, a robot hand, and a prepreg suitable therefor. The prepreg includes a CFRP sheet composed of resin composition (a) containing 100 parts by mass of cyanate ester resin (a1) having in its molecule not less than 2 cyanate groups, 0.01 to 0.5 parts by mass of metal coordination catalyst (a2), and 1 to 20 parts by mass of thermoplastic, toughness enhancer (a3), and carbon fibers (b) containing carbon fibers (b1) having a tensile elastic modulus of not lower than 450 GPa. The prepreg is useful for a supporting section of a robot hand.

### FIELD OF ART

The present invention relates to carbon-fiber-reinforced composite materials, robot hands, and prepreg for use therefor, that are particularly low in saturated water absorption, excellent in Total Mass Loss (TML), Collected Volatile Condensable Material (CVCM), and heat resistance, and also excellent in resistance to deformation, such as flexural rigidity.

### BACKGROUND ART

The industry has been demanding fiber-reinforced composite materials that are lighter in weight and tougher, and have high resistance to fire, impact, and deformation. Fiber-reinforced composite materials are demanded that can withstand long-term use under severe conditions, and are usable, for example, for robots in manufacturing settings in various industries, high-speed rotating rollers used in plate making or printing, and space industry.

JP 2011-183470-A discloses a robot hand utilizing a carbon-fiber-reinforced plastic shaped body composed of a laminate of carbon-fiber-reinforced plastic layers and vibration-damping elastic layers containing a viscoelastic resin and a high-rigidity resin.

JP 2011-183471-A discloses a robot hand utilizing a carbon-fiber-reinforced plastic shaped body composed of a laminate of carbon-fiber-reinforced plastic layers and vibration-damping elastic layers containing a viscoelastic resin and a high-rigidity fibrous substance.

The carbon-fiber-reinforced plastic shaped bodies disclosed in these publications have excellent vibration-damping property and certain flexural rigidity, but such flexural rigidity, representing resistance to deformation, is not necessarily sufficient. On the other hand, fiber-reinforced composite materials having sufficient saturated water absorption, TML, and CVCM have not been obtained.

### SUMMARY OF THE INVENTION

It is an object of the present invention to provide a carbon-fiber-reinforced composite material that has a particularly low saturated water absorption, and excellent TML, CVCM, and heat resistance, as well as a robot hand and prepreg suitable therefor.

It is another object of the present invention to provide a carbon-fiber-reinforced composite material that has a particularly low saturated water absorption, excellent TML, CVCM, and heat resistance, and also excellent resistance to deformation, such as flexural rigidity, and that can withstand long-term use under severe conditions, as well as a robot hand and prepreg suitable therefor.

According to the present invention, there is provided prepreg comprising carbon-fiber-containing resin sheet (sometimes referred to as CFRP sheet hereinbelow) (c1) consisting of:

resin composition (a) comprising 100 parts by mass of cyanate ester resin (a1) having in its molecule not less than two cyanate groups (sometimes referred to as component (a1) hereinbelow), 0.01 to 0.5 parts by mass of metal coordination catalyst (a2) (sometimes referred to as component (a2) hereinbelow), and 1 to 20 parts by mass of thermoplastic, toughness enhancer (a3) (sometimes referred to as component (a3) hereinbelow), and

carbon fibers (b) comprising carbon fibers (b1) having a tensile elastic modulus of not lower than 450 GPa (sometimes referred to as component (b1) hereinbelow).

According to the present invention, there is also provided a carbon-fiber-reinforced composite material obtained by heat-curing the prepreg (sometimes referred to as the present composite material hereinbelow).

According to the present invention, there is further provided a robot hand having a support section for supporting an object to carry, wherein said support section comprises the composite material of the present invention.

According to the present invention, there is also provided resin composition (a) for prepreg comprising 100 parts by mass of component (a1), 0.01 to 0.5 parts by mass of component (a2), and 1 to 20 parts by mass of component (a3).

The composite material and the robot hand according to the present invention, which utilize the prepreg including the CFRP sheet (c1) of the construction discussed above, are particularly low in saturated water absorption, excellent in TML, CVCM, and heat resistance, and also in resistance to deformation, such as flexural rigidity. Thus the composite material and the robot hand of the present invention can withstand long-term use under severe conditions, and usable in the field of, for example, space industry.

### BRIEF DESCRIPTION OF THE DRAWINGS

FIG. 1 is a fragmented, schematic perspective view showing an embodiment of the robot hand.

FIG. 2 is a sectional view taken along lines A-A in FIG. 1.

FIG. 3 illustrates the size of the sectional opening of the robot hand used in the flexural rigidity evaluation test conducted in Examples and Comparative Examples.

FIG. 4 is a schematic view for illustrating the flexural rigidity evaluation test conducted in Examples and Comparative Examples.

### PREFERRED EMBODIMENTS OF THE INVENTION

The present invention will now be explained in detail.

The resin composition (a) used in the prepreg of the present invention contains components (a1) to (a3) discussed above at a particular ratio. Component (a1) is a cyanate ester resin having in its molecule not less than two cyanate groups, and may be represented by, e.g., formula (I):

AO—C≡N)ₙ (I)

wherein n is an integer of 2 or more, and A is an n-valent organic group.

Examples of the cyanate ester resin represented by formula (I) may include 1,3- or 1,4-dicyanobenzene; 4,4′-dicyanobiphenyl; an ortho-substituted dicyanate ester represented by formula (II):

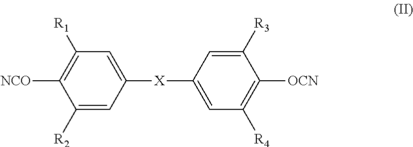

wherein R₁ to R₄ may be the same or different and each is a hydrogen atom or a methyl group, and X is an alkylene group having 1 to 4 carbon atoms, a phenylene group, an alkylene group having an aromatic group, —O—, —S—, —SO₂—, or —CO—;
a poly(phenylene oxide)cyanate ester represented by formula (III):

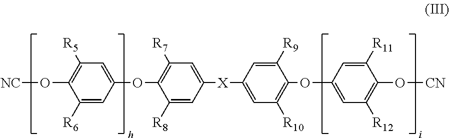

wherein h is an integer of h≧0, i is an integer of i≧1, R₅ to R₄₂ may be the same or different and each is a hydrogen atom or a methyl group, and X is the same as in formula (II);
a tricyanate ester represented by formula (IV):

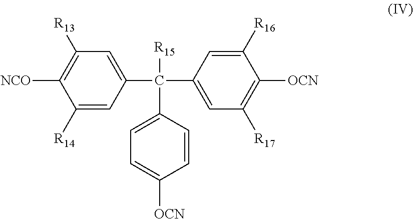

wherein R₁₃ to R₁₇ are the same or different and each is a hydrogen atom or a methyl group; or
a polycyanate ester represented by formula (V):

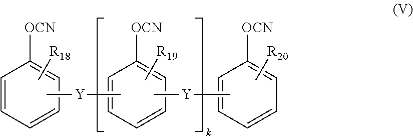

wherein k is an integer of 1 or more, R₁₈ to R₂₀ are the same or different and each is a hydrogen atom or a methyl group, and Y is an alkylene group having 1 to 6 carbon atoms.

Component (a1) may be any main precursor capable of giving a desired cured product of resin composition (a), and may be a monomer, an oligomer, or a prepolymer of a cyanate ester having in its molecule not less than 2 cyanate groups, or a mixture thereof. A polytriazine obtained by trimerization of a cyanate ester resin may also be used as well. For example, a trimer of a cyanate ester resin represented by formula (1), polytriazine, is represented by formula (VI):

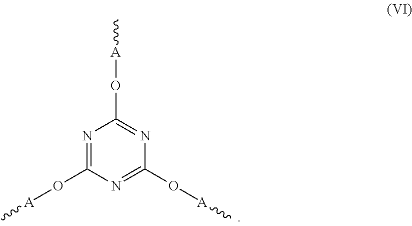

Component (a1) maybe a commercial product, for example, bisphenol A dicyanate(2,2-bis(4-cyanophenyl)isopropylidene) or prepolymer mixtures thereof (a mixture of a cyanate ester resin and polytriazine) Primaset™ BADCy, BA200, or BA3000 (all trade names, LONZA), B-10 or B-30 (both trade names, HUNTSMAN); bisphenol AD dicyanate(1,1′-bis(4-cyanophenyl)ethane) Primaset™ LECy (trade name, LONZA) or L-10 (trade name, HUNTSMAN); dicyanate of substituted bisphenol F or prepolymer mixtures thereof Primaset™ METHYLCy (trade name, LONZA), M-10 or M-30 (both trade names, HUNTSMAN); a cyanate ester of an addition product of phenol and dicyclopentadiene XU-71787-02 (trade name, HUNTSMAN); a phenol novolac cyanate ester or prepolymer mixtures thereof Primaset™ PT-15, PT-30, or PT-60 (all trade names, LONZA); or dicyclopentadiene-modified phenol cyanate ester or prepolymer mixtures thereof Primaset™ DT-4000 or DT-7000 (both trade names, LONZA).

Component (a1) may preferably contain a phenol novolac cyanate ester resin for further improvement in heat resistance of the present composite material to be discussed later. The content of the phenol novolac cyanate ester resin, if contained, in component (a1) is preferably not less than 30 mass % and not more than 80 mass %, more preferably not less than 50 mass % and not more than 80 mass %. At over 80 mass %, the composite material may have higher heat resistance, but lower toughness and impaired long-term durability.

In resin composition (a), component (a2) is a metal coordination catalyst. Examples of component (a2) may include copper acetylacetonate, cobalt (III) acetylacetonate (abbreviated as Co(acac)₃ hereinbelow), zinc octylate, tin octylate, zinc naphthenate, cobalt naphthenate, tin stearate, zinc stearate, and chelated compounds of iron, cobalt, zinc, copper, manganese, or titanium and a bidentate ligand, such as catechol. For balanced curability, shapability, and pot life of resin composition (a), component (a2) is preferably Co(acac)₃.

The content of component (a2) is 0.01 to 0.5 parts by mass, preferably 0.03 to 0.3 parts by mass, with respect to 100 parts by mass of component (a1) for balanced curability and stability of resin composition (a). At over 0.5 parts by mass, resin composition (a) gels in a short time during the heat-curing for preparation of the composite material to be discussed later, and will not cure homogeneously to cause voids. At less than 0.01 part by mass, curing requires excessive time, which is not practical.

In resin composition (a), component (a3) is a thermoplastic, toughness enhancer. Examples of component (a3) may include copolymerized polyester resins, polyimide resins, polyamide resins, polyether sulfone, acrylic resins, butadiene-acrylonitrile resins, styrenic resins, olefinic resins, nylon resins, butadiene-alkylmethacrylate-styrene copolymers, acrylate-methacrylate copolymers, and mixtures thereof.

Component (a3) may be dissolved or dispersed as fine particles in resin composition (a). When in the form of fine particles, component (a3) preferably has an average particle size of not larger than 100 μm.

The content of component (a3) is 1 to 20 parts by mass, preferably 2 to 15 parts by mass, with respect to 100 parts by mass of component (a1). At less than 1 part by mass, a toughness improving effect on the composite material to be discussed later is no sufficient, whereas at over 20 parts by mass, the desired resistance to deformation may not be achieved.

Resin composition (a) may optionally contain components other than components (a1) to (a3), as long as the effects of the present invention are not impaired. For example, resins other than components (a1) to (a3) may be contained. Examples of such resins may include thermosetting resins, such as epoxy, polyester, polyurethane, urea, phenol, melamine, or benzoxazine resin. However, for particularly superior low moisture absorption/desorption characteristics of the composite material, resin composition (a) is preferably substantially free of resin components other than components (a1) to (a3).

The viscosity of resin composition (a) is preferably 10 to 20000 Pa·s, more preferably 10 to 10000 Pa·s, most preferably 50 to 6000 Pa·s, at 50° C., for facilitating sheet forming in the production of CFRP sheets to be discussed later. At lower than 10 Pa·s, resin composition (a) has an excessively high tackiness, whereas at over 20000 Pa·s, resin composition (a) is semi solidified, both of which cause difficulties in the sheet forming.

For further improving the heat resistance of the present composite material to be discussed later, resin composition (a) preferably has a glass transition temperature of not lower than 250° C. and not higher than 350° C. Resin composition (a) having such a property may preferably be free of resin components other than components (a1) to (a3), and may preferably contain a phenol novolac cyanate ester resin as component (a1).

Resin composition (a) may be prepared by mixing the components including components (a1) to (a3) in a conventional manner, for example, in a kneader, a planetary mixer, or a twin-screw extruder. When in the form of fine particles, component (a3) is preferably dispersed preliminarily in the liquid resin components, such as component (a1), by means of a homomixer, a three-roll mill, a ball mill, a beads mill, or ultrasound. Further, the mixing or the preliminary dispersion of the fine particles may be carried out under heating/cooling or increased/decreased pressure, as necessary. In view of the storage stability, the mixed resin composition (a) is preferably placed in a refrigerator or freezer immediately for storage.

The prepreg according to the present invention essentially includes CFRP sheet (c1) composed of resin composition (a) discussed above and carbon fibers (b) containing carbon fibers (b1) with a particular tensile elastic modulus. When in the form of a laminate, the prepreg further includes CFRP sheet (c2) composed of resin composition (a) discussed above and carbon fibers (b2) with a particular tensile elastic modulus (sometimes referred to as component (b2) hereinbelow).

Carbon fibers are categorized into polyacrylonitrile (PAN)-based carbon fibers and pitch-based carbon fibers, depending on their raw materials. Pitch-based carbon fibers have higher tensile elastic modulus, whereas PAN-based carbon fibers have higher tensile strength. The carbon fibers used in the present invention may either be PAN- or pitch-based carbon fibers, with pitch-based carbon fibers being preferred for the resistance to deformation of the present composite material.

Component (b1) in the present invention is carbon fibers having a tensile elastic modulus of not lower than 450 GPa, preferably not lower than 600 GPa. The upper limit of the tensile elastic modulus is not necessarily set, and may practically be about 900 GPa. By employing CFRP sheet (c1) containing such component (b1) in the prepreg, the heat resistance, the impact resistance, the resistance to deformation, such as flexural rigidity, of the present composite material may be improved.

The content of component (b1) in carbon fibers (b) used in CFRP sheet (c1) to be discussed later in the prepreg of the present invention is usually not less than 70 mass %, preferably not less than 80 mass %, most preferably 100 mass %, of carbon fibers (b) for further improvement in flexural rigidity of the present composite material. The content of component (b1) in CFRP sheet (c1) in the prepreg of the present invention is preferably 20 to 90 mass %, more preferably 30 to 85 mass %, most preferably 40 to 80 mass %, of CFRP sheet (c1). At less than 20 mass %, excess amount of resin composition (a) may disturb the advantageous specific strength and specific elasticity of the present composite material, and excess amount of heat may be generated during heat-curing. At over 90 mass %, defect of impregnation with resin composition (a) may occur, resulting in a composite material with increased voids.

Component (b2) in CFRP sheet (c2) optionally included in the present prepreg is carbon fibers having a tensile elastic modulus of lower than 450 GPa, of which lower limit is not particularly set.

By employing such CFRP sheet (c2) in the prepreg of the present invention, flexural rigidity and vibration-damping property may be well balanced in the present composite material.

In CFRP sheet (c2) optionally included in the prepreg of the present invention, the content of component (b2) is preferably 20 to 90 mass %, more preferably 30 to 85 mass %, most preferably 40 to 80 mass %. At less than 20 mass %, excess amount of resin composition (a) may disturb the advantages of the present invention, and excess amount of heat may be generated during heat-curing. At over 90 mass %, defect of impregnation with resin composition (a) may occur, resulting in a composite material of the present invention with increased voids.

The CFRP sheets in the present prepreg may be prepared according to a known process, for example, by impregnating a unidirectional sheet of carbon fibers oriented in one direction, or a fabric sheet, such as plain, twill, sateen, or triaxial weave, of carbon fibers, with resin composition (a). In this regard, for example, a plurality of CFRP sheets with different carbon fiber orientations may be combined for optimal flexural rigidity according to a known method, depending on where to locate the composite material.

A carbon fiber sheet may be impregnated with resin composition (a) by a wet method, wherein the viscosity of resin composition (a) is lowered by dissolving in a solvent, such as methyl ethyl ketone or methanol, before impregnation, or by a hot melt method (dry method), wherein the viscosity is lowered by heating before impregnation.

The wet method includes soaking a carbon fiber sheet in a solution of resin composition (a), drawing the sheet up, and evaporating the solvent in an oven or the like. The hot melt method includes directly impregnating a carbon fiber sheet with resin composition (a) of which viscosity has been lowered by heating; or applying resin composition (a) onto a release paper to prepare a film of the composition, overlaying the carbon fiber sheet with the film on one or both sides, and subjecting the sheet with the film to heat and pressure to infiltrate resin composition (a) into the carbon fiber sheet. The hot melt method is preferred for substantially no solvent remaining in the obtained prepreg.

The prepreg of the present invention preferably has a carbon fiber content of 70 to 1000 g/m² per unit area of the CFRP sheet. At less than 70 g/m², an increased number of the CFRP sheets are required for giving a predetermined thickness to the composite material of the present invention, which may complicate the operation. On the other hand, at over 1000 g/m², resin composition (a) may not infiltrate sufficiently, resulting in a heat-cured composite material with increased voids.

The prepreg of the present invention may either be a single uncured CFRP sheet (c1), or an uncured laminate including at least one CFRP sheet (c1). In the case of a laminate, CFRP sheet (c1) may preferably be combined suitably with CFRP sheet (c2) to form a laminate, for further improving resistance to deformation and vibration-damping property of the resulting composite material. A specific example of a laminate has a middle layer composed of at least one CFRP sheet (c1), and two outer layers sandwiching the middle layer and each composed of at least one CFRP sheet (c2).

In the prepreg of the present invention, when in the form of a laminate, preferably not less than two-thirds of the CFRP sheets are CFRP sheets (c1). When more than a half of the CFRP sheets constituting the laminate are CFRP sheets (c1), the resulting carbon-fiber-reinforced composite material has excellent resistance to deformation, such as flexural rigidity, in addition to resistance to heat and impact.

An example of a laminate structure of the present prepreg preferred for application to a robot hand is discussed next.

Robot hands are required to be hard to yield when loaded with an object to carry, i.e. required to have a high flexural rigidity. This high flexural rigidity may be achieved with unidirectional sheets of highly-elastic carbon fibers oriented in one direction, by laminating the sheets with the orientation of the carbon fibers aligned to the longitudinal direction of the robot hand. If unidirectional sheets are laminated with the orientation of the carbon fibers at right angles to the longitudinal direction of the robot hand, no carbon fiber is oriented in this longitudinal direction, which lowers the strength of the prepreg. When such a prepreg is used as a robot hand, defects may often occur, such as longitudinal splits or cracks.

In the light of this, when a robot hand in the form of a square pipe is fabricated from the sheets for the middle layer and the sheets for the two outer layers sandwiching the middle layer, it is effective to use fabric sheets as the latter sheets for the two outer layers. Since fabric sheets are woven from carbon fibers oriented longitudinally and transversely, the carbon fibers are aligned not only to the longitudinal direction of the robot hand, but also at right angles thereto, so that generation of longitudinal splits and cracks may be prevented. A robot hand in the form of a plate may also be prevented from cracking by using fabric sheets as the two outer layers. When a robot hand which is to be subjected to processing such as piercing for attachment of suction pads or the like, or thread-cutting for attachment to a robot, is composed only of unidirectional sheets, burrs will be generated when processed, resulting in impaired surface conditions, whereas when composed with fabric sheets in the outer layers, generation of burrs may be prevented.

The composite material according to the present invention is a carbon-fiber-reinforced composite material obtained by heat-curing the prepreg of the present invention discussed above.

The composite material of the present invention has a TML of preferably not more than 0.35%, more preferably not more than 0.30%, a CVCM of preferably less than 0.002%, more preferably not more than 0.001%, and a saturated water absorption of preferably not more than 3.0%, more preferably not more than 1.5%.

The TML and CVCM are measured pursuant to ASTM E595-06, and calculated according to the following formulae:

TML (%)=[(Specimen mass before test−Specimen mass after test)]/Specimen mass before test]×100

CVCM (%)=[(Collector plate mass after test−Collector plate mass before test)/Specimen mass before test]×100

The saturated water absorption is calculated according to the following formula:

Saturated water absorption (%)=(Specimen mass after water absorption−Specimen mass before water absorption)/Specimen mass before water absorption]×100

The heat-curing of the prepreg for obtaining the present composite material may be performed under any conditions as long as component (a1) is acted upon by component (a2) to undergo cross-linking to thereby cause curing of resin composition (a). For example, the prepreg may be heated at not lower than 120° C. and not higher than 200° C., preferably not lower than 150° C. and not higher than 200° C., to cure resin composition (a). The curing time is not particularly limited, and is usually about 1 to 5 hours, preferably about 2 to 4 hours.

The composite material of the present invention obtained in this way has heat resistance at usually not lower than 150° C. Further, by post-curing at 200 to 300° C. following the above-mentioned heat-curing, heat resistance at not lower than 250° C. may be achieved at most. Thus, such post-curing may preferably be carried out. The time for the post-curing is not particularly limited, and may be about 1 to 20 hours.

The heat-curing may be carried out in a press or an autoclave. In an autoclave, in particular, the present prepreg is cured in a vacuum bag. By not only reducing pressure in the vacuum bag, but also increasing pressure in the autoclave, air and voids entrained in the prepreg may be eliminated.

The composite material according to the present invention may find applications in robots, such as robot hands used in manufacturing settings in various industries, high-speed rotating rollers used in plate making or printing, or space industry.

A robot hand is apart of an industrial robot, and has a support section for supporting an object to carry, such as assembling parts, during production of parts or final products. Robot hands have been playing more and more important roles with the automation of factory lines, and further improvement in transportation velocity and precision is demanded. In particular, robot hands for transferring substrates used in production of precision parts, such as liquid crystal displays (LCD), plasma display panels (PDP), or semiconductor wafers, are required to have high flexural rigidity so as to avoid any deformation or flexure upon supporting a relatively heavy, expensive glass substrate thereon. In the case of transferring in a vacuum chamber, such as in the production process of organic EL devices, robot hands, if made of a conventional fiber-reinforced composite material having higher TML and CVCM, will pose a problem in the production process. Further, since moisture should definitely be avoided in such a production process, it is also demanded of the composite material to have as low a saturated water absorption as possible, which represents the moisture content of the material. However, the saturated water absorption of a conventional fiber-reinforced composite material does not fulfill such a demand.

The composite material of the present invention, which has extremely lower TML, CVCM, and saturated water absorption compared to those of the conventional fiber-reinforced composite materials, can indicate excellent performance as a supporting section for supporting an object to carry, of a robot hand used in the production of precision parts or precision machinery.

An embodiment of a robot hand fabricated from the composite material of the present invention will now be explained with reference to the drawings.

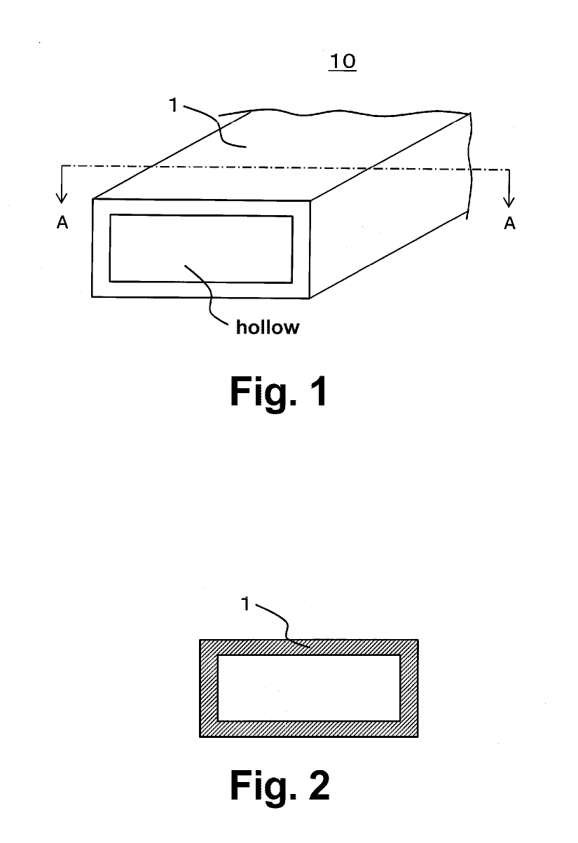

Referring to FIG. 1, robot hand 10 is made of the composite material of the present invention processed into a hollow rectangular member, and part of it is designated as 1, and the cross-section taken along lines A-A is shown in FIG. 2. The cross-section of the robot hand 10 as shown in FIG. 2 is rectangular, but the cross-sectional shape of the robot hand of the present invention is not limited to this, and may be of any shape, such as polygonal, semicircular, or circular, according to the requirement for an object to carry.

The robot hand 10 may be produced, for example, by the following process. First, a core (mandrel), which will not be deformed at the curing temperature of resin composition (a), is provided. The mandrel may be made of a metallic material, such as iron or aluminum, or a resin material, such as nylon. When the robot hand to be produced is, for example, in the form of a square pipe, the mandrel may be of generally the same size as the interior size of the square pipe.

Next, the CFRP sheets discussed above for use in the prepreg of the present invention, which have been cut into a predetermined size, are wound onto the mandrel one after another. For producing a robot hand in the form of a square pipe, the first and the last CFRP sheets wound on the mandrel are preferably the fabric sheets, for example, CFRP sheets (c2) discussed above. The middle layer sandwiched between the fabric sheets is preferably a laminate of a predetermined thickness of the unidirectional sheets of which carbon fibers are generally aligned to the longitudinal direction of the robot hand.

The prepreg thus prepared by the above lamination is then covered with a release film, and placed in a vacuum bag, which in turn is placed in an autoclave, pressurized, and heated while the vacuum bag is decompressed, to thereby cure resin composition (a) in the laminate. Then the prepreg is taken out of the autoclave and of the vacuum bag, and the mandrel is drawn out, to give a robot hand 10 in the form of a square pipe.

### EXAMPLES

The present invention will now be explained with reference to Examples, which are illustrative only and do not intend to limit the present invention.

### Example 1-1

Forty parts by mass of a phenol novolac cyanate ester resin Primaset™ PT-60 (trade name, LONZA), 20 parts by mass of Primaset™ PT-30 (trade name, LONZA), and 40 parts by mass of a bisphenol cyanate ester resin Primaset™ BA-200 (trade name, LONZA), as component (a1); 0.06 parts by mass of Co(acac)₃ as component (a2); and 3 parts by mass of polyether sulfone ULTRASON™ E 2020P SR MICRO (trade name, BASF) as component (a3), were mixed in a planetary mixer to prepare resin composition (a), which was then applied to a release paper to obtain a precursor film. Carbon fibers having a tensile elastic modulus of 780 GPa, XN-80 (trade name, NIPPON GRAPHITE FIBER CORPORATION), were prepared into a unidirectional sheet. The precursor film was placed on the unidirectional sheet, and subjected to heat and pressure to infiltrate into the sheet, to thereby obtain CFRP sheet (c1) having a fiber areal weight (AFW) of 256 g/m2.The sheet was 0.21 mm thick.

Then fourteen of the thus obtained CFRP sheets (c1) were laminated with the carbon fibers unidirectionally aligned, to prepare a prepreg. The prepreg was heat-cured at 180° C. for 2 hours in an autoclave to obtain a carbon-fiber-reinforced composite material with a resin impregnation ratio of 31.4 mass %. This carbon-fiber-reinforced composite material was subjected to the following measurements. The results are shown in Table 1.

### <Measurements of TML and CVCM>

The carbon-fiber-reinforced composite material was processed into a specimen of 3 mm wide×3 mm long×3 mm high, and subjected to measurements pursuant to ASTME 595-06. The TML and the CVCM were calculated according to the above formulae.

### <Measurement of Saturated Water Absorption>

The obtained carbon-fiber-reinforced composite material was processed into a specimen of 10 mm wide×60 mm long×2 mm thick. The specimen was soaked in warm water at 93° C. for 20 days to absorb water to saturation. The mass of the specimen before and after the soaking were measured, and the saturated water absorption was calculated according to the above formula.

### <Measurement of Glass-Transition Temperature>

Resin composition (a) was introduced at 100° C. into a mold, and cured at 180° C. for 2 hours to obtain a resin plate. Temperature-dependency of the storage elastic modulus was measured with a dynamic viscoelastometer ARES (trade name, TA INSTRUMENTS), and a point of sharp drop of the modulus of elasticity was calculated by the tangent method and taken as the glass-transition temperature.

### Comparative Example 1-1

A carbon-fiber-reinforced composite material was prepared in the same way as in Example 1-1, except that component (a1) was replaced with 30 parts by mass of bisphenol A epoxy resin YD-128 (trade name, NIPPON STEEL & SUMIKIN CHEMICAL CO., LTD.) and 30 parts by mass of glycidyl amine epoxy resin YH434L (trade name, NIPPON STEEL & SUMIKIN CHEMICAL CO., LTD.), and component (a2) was replaced with 30 parts by mass of 4,4′-diamino diphenyl amine SEIKACURE-S (trade name, WAKAYAMA SEIKA KOGYO CO., LTD.). The composite material thus obtained was subjected to the measurements in the same way as in Example 1-1. The results are shown in Table 1.

### Comparative Example 1-2

A carbon-fiber-reinforced composite material was prepared in the same way as in Example 1-1, except that component (a1) was replaced with 25 parts by mass of bisphenol A epoxy resin YD-128 (trade name, NIPPON STEEL & SUMIKIN CHEMICAL CO., LTD.), 35 parts by mass of bisphenol A epoxy resin YD-011 (trade name, NIPPON STEEL & SUMIKIN CHEMICAL CO., LTD.), and 40 parts by mass of phenol novolac epoxy resin YDPN-638 (trade name, NIPPON STEEL & SUMIKIN CHEMICAL CO., LTD.), component (a2) was replaced with 5 parts by mass of dicyandiamide (TOKYO CHEMICAL INDUSTRY CO., LTD.) and 3 parts by mass of DCMU (HODOGAYA CHEMICAL CO., LTD.), and component (a3) was replaced with 10 parts by mass of a phenoxy resin YP-70 (trade name, NIPPON STEEL & SUMIKIN CHEMICAL CO., LTD.), and heat-curing was carried out at 130° C. for 1 hour. The composite material thus obtained was subjected to the same measurements as in Example 1-1. The results are shown in Table 1.

TABLE 1

| | | Example | Comp. Ex. | Comp. Ex. |
|---|---|---|---|---|
| | | 1-1 | 1-1 | 1-2 |
| Component (a1) | PT-60*¹ | 40 | — | — |
| (part by mass) | PT-30*¹ | 20 | — | — |
| | BA-200*² | 40 | — | — |
| Resin | YD-128*³ | — | 30 | 25 |
| (part by mass) | YD-011*³ | — | — | 35 |
| | YDPN-638*⁴ | — | — | 40 |
| | YH434L*⁵ | — | 30 | — |
| Component (a2) | Co(acac)₃*⁶ | 0.06 | — | — |
| (part by mass) | | | | |
| Catalyst | SEIKACURE-S*⁷ | — | 30 | — |
| (part by mass) | Dicyandiamide*⁸ | — | — | 5 |
| | DCMU*⁹ | — | — | 3 |
| Component (a3) | Polyether | 3 | 3 | — |
| (part by mass) | sulfone*¹⁰ | | | |
| | YP-70*¹¹ | | — | 10 |

| | | | |
|---|---|---|---|
| Resin content (mass %) | 31.4 | 31.4 | 31.4 |
| CF (carbon fibers)*¹² (AFW in g/m²) | 250 | 250 | 250 |
| TML (%) | 0.245 | 0.365 | 0.426 |
| CVCM (%) | 0.000 | 0.004 | 0.002 |
| Saturated water absorption (%) | 0.9 | 3.8 | 6.0 |
| Glass-transition temperature (° C.) | 275 | 230 | 125 |

*¹Phenol novolac cyanate ester (LONZA)
*²Bisphenol cyanate ester (LONZA)
*³Bisphenol A epoxy resin (NIPPON STEEL & SUMIKIN CHEMICAL CO., LTD.)
*⁴Phenol novolac epoxy resin (NIPPON STEEL & SUMIKIN CHEMICAL CO., LTD.)
*⁵Glycidyl amine epoxy resin (NIPPON STEEL & SUMIKIN CHEMICAL CO., LTD.)
*⁶Cobalt (III) acetylacetonate (TOKYO CHEMICAL INDUSTRY CO., LTD.)
*⁷4,4-diamino diphenyl amine (WAKAYAMA SEIKA KOGYO CO., LTD.)
*⁸TOKYO CHEMICAL INDUSTRY CO., LTD.
*⁹3-(3,4-dichlorophenyl-1,1-dimethylurea (HODOGAYA CHEMICAL CO., LTD.
*¹⁰ULTRASON ™ E 2020P SR MICRO (BASF)
*¹¹Phenoxy resin (NIPPON STEEL & SUMIKIN CHEMICAL CO., LTD.)
*¹²XN-80 (NIPPON GRAPHITE FIBER CORPORATION), tensile elastic modulus: 780 GPa

### Example 2-1

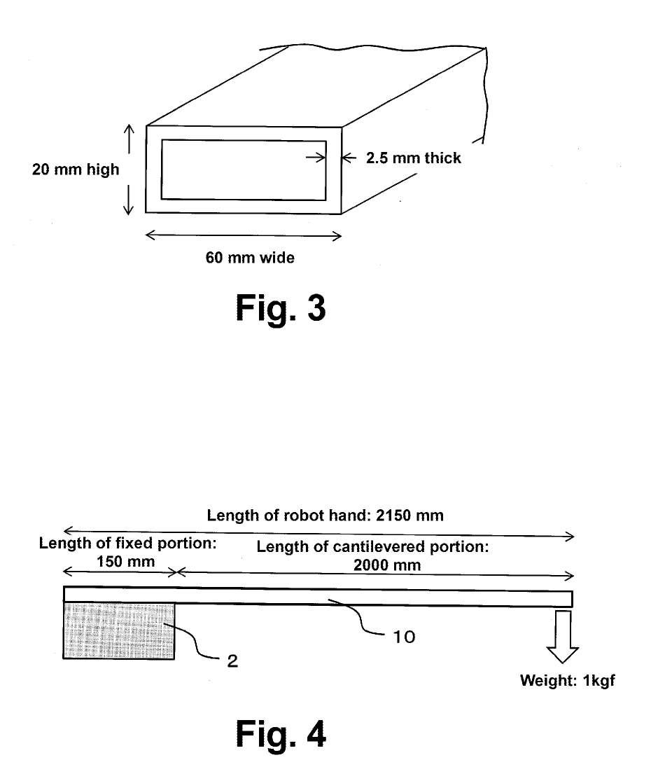

CFRP sheets, PPG-A and PPG-E, shown in Table 2 below were prepared from resin composition (a) prepared in Example 1-1 and the carbon fibers (CF) shown in Table 2. These sheets were wound on a mandrel to fabricate a prepreg having a laminated structure as shown in Table 3. The prepreg was then heat-cured at 180° C. for 4 hours to give a robot hand of 2150 mm long having a cross-sectional opening of the size as shown in FIG. 3. The robot hand thus obtained was subjected to the following flexural rigidity test. The results are shown in Table 3.

Incidentally, in Table 3, the CF orientation angle of “0°” means that the carbon fibers were aligned to the longitudinal direction of the robot hand, whereas “0°/90°” means plain weave wherein the carbon fibers were arranged in alignment with the longitudinal direction and at right angles thereto.

### <Flexural Rigidity Test>

Robot hand 10 of 2150 mm long produced above was cantilevered with one of its ends horizontally fixed on fixing base 2 over 150 mm from the end as shown in FIG. 4. A 1 kgf weight was suspended at the other end 2000 mm away from the fixing base 2, and the flexure at this end was determined. A flexure of not more than 5 mm was acceptable.

### Examples 2-2 and 2-3 and Comparative Example 2-1

A robot hand was produced in the same way as in Example 2-1, except that the CFRP sheets and the laminate structure of the prepreg were as shown in Table 3, and subjected to the flexural rigidity test in the same way as in Example 2-1. The results are shown in Table 3.

Incidentally, PPG-B, PPG-C, and PPG-D in Tables 2 and 3 were prepared in the same way as with PPG-A in Example 2-1, except that the CF as shown in Table 2 was used.

TABLE 2

| | Resin | | | Thickness of |
|---|---|---|---|---|
| CFRP | content | CF | | CFRP sheet |
| sheet | (mass %) | Kind | AFW (g/m²) | (mm) |
| PPG-A | 32.0 | XN-80*¹ | 235 | 0.199 |
| PPG-B | 32.0 | XN-60*² | 230 | 0.197 |
| PPG-C | 32.0 | HS40*³ | 215 | 0.199 |
| PPG-D | 32.0 | T700S*⁴ | 210 | 0.198 |
| PPG-E | 43.0 | T300*⁵ | 198 | 0.251 |

*¹Pitch-based; Tensile elastic modulus: 780 GPa; NIPPON GRAPHITE FIBER CORPORATION
*²Pitch-based; Tensile elastic modulus: 620 GPa; NIPPON GRAPHITE FIBER CORPORATION
*³PAN-based; Tensile elastic modulus: 455 GPa; MITSUBISHI RAYON CO., LTD.
*⁴Pitch-based; Tensile elastic modulus: 230 GPa, TORAY INDUSTRIES, INC.
*⁵PAN-based; Tensile elastic modulus: 230 GPa, TORAY INDUSTRIES, INC.

TABLE 3

| | | | Number | Layer | Plate | | Tip |
|---|---|---|---|---|---|---|---|
| | | CFRP | of | thickness | thickness | CF | flexure |
| | | sheet | sheets | (mm) | (mm) | orientation | (mm) |
| Example | Outer | PPG-E | 1 | 0.251 | 2.49 | 0°/90° | 3.3 |
| 2-1 | layer | | | | | | |
| | Middle | PPG-A | 10 | 1.990 | | 0° | |
| | layer | | | | | | |
| | Outer | PPG-E | 1 | 0.251 | | 0°/90° | |
| | Layer | | | | | | |
| Example | Outer | PPG-E | 1 | 0.251 | 2.47 | 0°/90° | 3.9 |
| 2-2 | layer | | | | | | |
| | Middle | PPG-B | 10 | 1.970 | | 0° | |
| | Layer | | | | | | |
| | Outer | PPG-E | 1 | 0.251 | | 0°/90° | |
| | layer | | | | | | |
| Example | Outer | PPG-E | 1 | 0.251 | 2.49 | 0°/90° | 4.9 |
| 2-3 | layer | | | | | | |
| | Middle | PPG-C | 10 | 1.990 | | 0° | |
| | layer | | | | | | |
| | Outer | PPG-E | 1 | 0.251 | | 0°/90° | |
| | layer | | | | | | |
| Comp. Ex. | Outer | PPG-E | 1 | 0.251 | 2.48 | 0°/90° | 9.1 |
| 2-1 | layer | | | | | | |
| | Middle | PPG-D | 10 | 1.980 | | 0° | |
| | layer | | | | | | |
| | Outer | PPG-E | 1 | 0.251 | | 0°/90° | |
| | layer | | | | | | |

As clearly seen from Table 1, the carbon-fiber-reinforced composite materials of Examples had significantly lower TML, CVCM, and saturated water absorption and higher glass-transition temperature, compared to those of Comparative Examples, and were thus found to be carbon-fiber-reinforced composite materials with excellent heat resistance and the like properties. As clearly seen from Table 3, the robot hands of the Examples exhibited significantly less flexure compared to those of Comparative Examples, and were thus found to have excellent flexural rigidity.

Although the present invention has been described with reference to the preferred examples, it should be understood that various modifications and variations can be easily made by those skilled in the art without departing from the spirit of the invention. Accordingly, the foregoing disclosure should be interpreted as illustrative only and is not to be interpreted in a limiting sense. The present invention is limited only by the scope of the following claims.

What is claimed is:

1. A prepreg comprising a carbon-fiber-containing resin sheet (c1) consisting of:
resin composition (a) comprising 100 parts by mass of cyanate ester resin (a1) having in its molecule not less than two cyanate groups, 0.01 to 0.5 parts by mass of metal coordination catalyst (a2), and 1 to 20 parts by mass of thermoplastic, toughness enhancer (a3), and
carbon fibers (b) comprising carbon fibers (b1) having a tensile elastic modulus of not lower than 450 GPa.

2. The prepreg according to claim 1, further comprising carbon-fiber-containing resin sheet (c2) consisting of said resin composition (a) and carbon fibers (b2) having a tensile elastic modulus of lower than 450 GPa, wherein said prepreg is a laminate.

3. The prepreg according to claim 2, wherein said laminate consists of:
a middle layer consisting of at least one said carbon-fiber-containing resin sheet (c1), and
two outer layers sandwiching said middle layer, each consisting of at least one said carbon-fiber-containing resin sheet (c2).

4. The prepreg according to claim 1, wherein said carbon fibers (b1) have a tensile elastic modulus of not lower than 600 GPa.

5. The prepreg according to claim 3, wherein said carbon fibers (b1) have a tensile elastic modulus of not lower than 600 GPa.

6. The prepreg according to claim 1, wherein said cyanate ester resin (a1) having in its molecule not less than two cyanate groups comprises not less than 30 mass % and not more than 80 mass % of phenol novolac cyanate ester.

7. The prepreg according to claim 3, wherein said cyanate ester resin (a1) having in its molecule not less than two cyanate groups comprises not less than 30 mass % and not more than 80 mass % of phenol novolac cyanate ester.

8. A carbon-fiber-reinforced composite material obtained by heat-curing the prepreg of claim 1.

9. The composite material according to claim 8, wherein said composite material has a TML of not more than 0.35% and a CVCM of less than 0.002%.

10. The composite material according to claim 8, wherein said composite material has a saturated water absorption of not more than 3.0%.

11. The composite material according to claim 8, wherein said resin composition (a), when heat-cured by itself, has a glass-transition temperature of not lower than 250° C. and not higher than 350° C.

12. A robot hand having a supporting section for supporting an object to carry, wherein said support section comprises the composite material according to claim 8.
